(19) United States
(12) Patent Application Publication
(10) Pub. No.: US 2014/0325094 A1
(43) Pub. Date: Oct. 30, 2014

(54) INFORMATION PROCESSOR AND DISPLAY CONTROL METHOD

(71) Applicant: Kabushiki Kaisha Toshiba, Tokyo (JP)

(72) Inventor: Akira NAKANISHI, Tokyo (JP)

(73) Assignee: Kabushiki Kaisha Toshiba, Tokyo (JP)

(21) Appl. No.: 14/150,884

(22) Filed: Jan. 9, 2014

(30) Foreign Application Priority Data
Apr. 26, 2013 (JP) 2013094517

(51) Int. Cl. G06F 11/30

(52) U.S. Cl. CPC G06F 11/3051
USPC 710/16

(57) ABSTRACT

According to one embodiment, an information processor is capable of expanding a function by connecting an external device therewith. The information processor includes a detector, an acquisition module, and a transmitter. The detector is configured to detect a connection with the external device. The acquisition module is configured to acquire, when the detector has detected the connection with the external device, graphical user interface (GUI) information to be used for providing a GUI of the external device from the external device. The transmitter is configured to transmit the GUI information to an operation terminal device capable of providing the GUI.

### CROSS-REFERENCE TO RELATED APPLICATIONS

This application is based upon and claims the benefit of priority from Japanese Patent Application No. 2013-094517, filed Apr. 26, 2013, the entire contents of which are incorporated herein by reference.

### FIELD

Embodiments described herein relate generally to an information processor and a display control method.

### BACKGROUND

With advancement in performance and multi-functionalization of a television, which is as an example of an information processor, there has been disclosed a new television capable of being customized and upgraded by using an external expansion module in a manner such that a portion of a function of the television is provided to the external device and an expansion slot to which the external device can be connected is provided on the television.

In general, there is provided an application (hereinafter, referred to as a remote control application) that makes it possible to operate a television remotely on a mobile terminal device (an example of an operation terminal device) such as a smart phone and a tablet. There is, however, no remote control application that expects customization and upgrade of the television by use of the external expansion module. Thus, it is a main concern to provide an appropriate user interface for the television on the mobile terminal device in accordance with addition and deletion of functions to and from the television with the use of the external expansion module.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram illustrating a configuration of a display control system according to an embodiment;

FIG. 2 is an exemplary view for explaining expansion slots of an information processor in the embodiment;

FIG. 3 is an exemplary view for explaining generation of IP addresses on expansion cards connected to the information processor in the embodiment;

FIG. 4 is an exemplary block diagram illustrating a configuration of a mobile terminal device in the embodiment;

FIG. 5 is an exemplary block diagram illustrating functional configurations of the information processor and the mobile terminal device in the embodiment;

FIG. 6 is an exemplary sequence diagram illustrating flow of processing of providing a graphical user interface (GUI) of the expansion card on the mobile terminal device in a display control system in the embodiment;

FIGS. 7A and 7B are exemplary views illustrating an example of an expansion card list that is transmitted from the information processor in the embodiment;

FIG. 8 is an exemplary view illustrating one example of GUI information that is transmitted from the information processor in the embodiment;

FIG. 9 is an exemplary view illustrating one example of an operation console that is displayed on the mobile terminal device in the embodiment;

FIG. 10 is an exemplary view for explaining processing of displaying the operation console on the mobile terminal device in the embodiment;

FIG. 11 is an exemplary view illustrating one example of an event that is transmitted with an operation on the operation console displayed on the mobile terminal device in the embodiment;

FIG. 12 is an exemplary sequence diagram illustrating flow of processing of providing a GUI of a new expansion card on the mobile terminal device in the display control system in the embodiment; and

FIGS. 13A and 13B are exemplary views for explaining processing of displaying GUIs of a plurality of expansion cards on the mobile terminal device comprised by the display control system in the embodiment.

### DETAILED DESCRIPTION

In general, according to one embodiment, an information processor is capable of expanding a function by connecting an external device therewith. The information processor comprises a detector, an acquisition module, and a transmitter. The detector is configured to detect a connection with the external device. The acquisition module is configured to acquire, when the detector has detected the connection with the external device, graphical user interface (GUI) information to be used for providing a GUI of the external device from the external device. The transmitter is configured to transmit the GUI information to an operation terminal device capable of providing the GUI.

Hereinafter, there is described an information processor and a display control method according to embodiments with reference to the accompanying drawings.

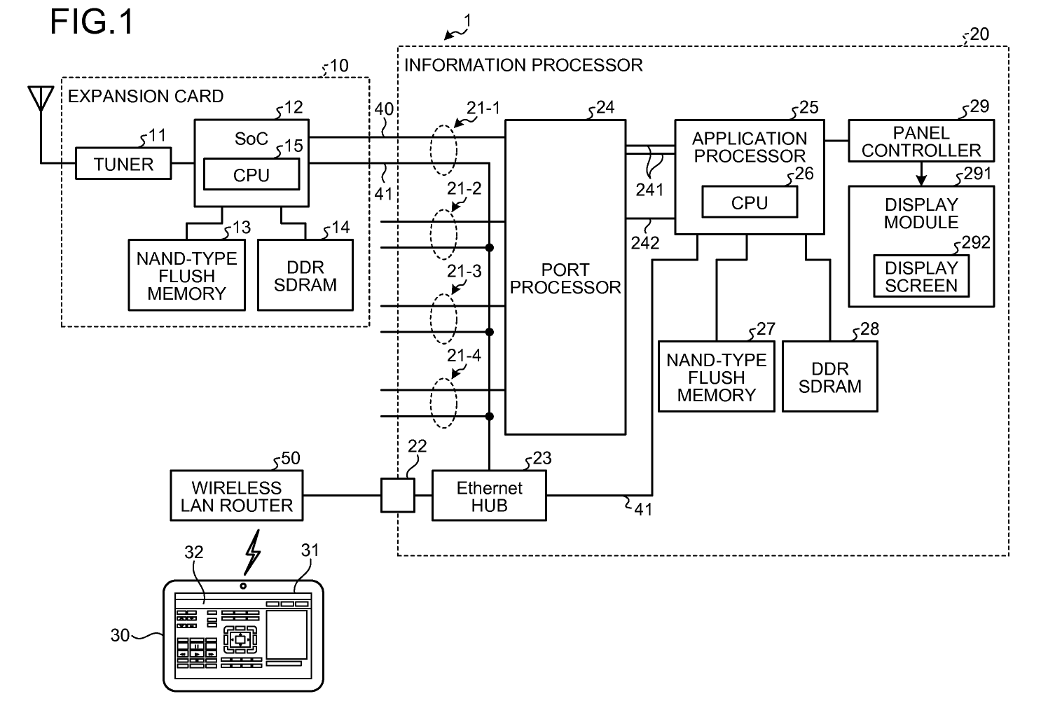

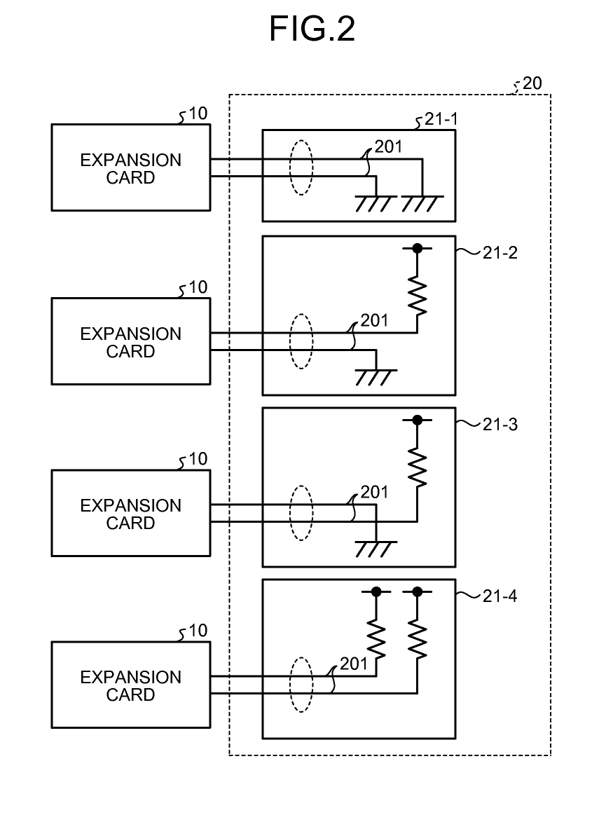

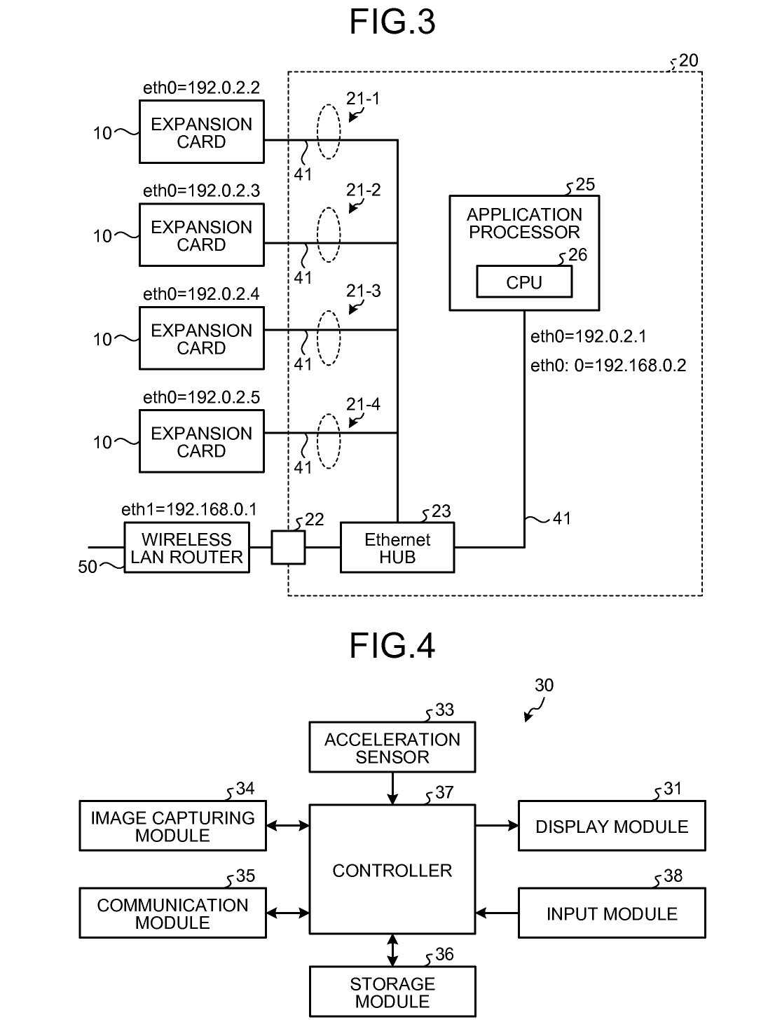

There is described a configuration of a display control system in the embodiment with reference to FIGS. 1 to 4. FIG. 1 is a block diagram illustrating the configuration of the display control system in the embodiment. FIG. 2 is a view for explaining expansion slots of an information processor in the embodiment. FIG. 3 is a view for explaining generation of Internet Protocol (IP) addresses of expansion cards connected to the information processor in the embodiment. FIG. 4 is a block diagram illustrating a configuration of a mobile terminal device in the embodiment.

A display control system 1 in the embodiment comprises an information processor 20 (for example, television and recorder) and a mobile terminal device 30 (for example, tablet terminal and smart phone). The function of the information processor 20 is capable of being expanded by connecting an expansion card 10 thereto. The mobile terminal device 30 is capable of receiving operations with respect to the information processor 20.

The expansion card 10 is an example of an external device capable of expanding the function of the information processor 20. For example, the expansion card 10 has a function of receiving specific broadcasting (for example, terrestrial television broadcasting, broadcast satellite (BS) television broadcasting, communication satellite (CS) television broadcasting, and cable television). Although there is described in the embodiment an example in which the expansion card 10 having the function of receiving the specific broadcasting is connected to the information processor 20, the external device is not limited thereto. For example, as external devices, an image processing device having a function of executing image processing on an image that is displayed on a display module comprised by the information processor 20, a recorder that stores therein broadcast data of broadcast video images and the like of broadcasting received by the information processor 20, and the like are capable of being connected to the information processor 20.

As illustrated in FIG. 1, the expansion card 10 having the function of receiving the specific broadcasting comprises a tuner 11, a system on a chip (SoC) 12, a NAND flash memory 13, and a double data rate synchronous dynamic random access memory (DDR SDRAM) 14. The tuner 11 receives specific broadcasting. The SoC 12 comprises a central processing unit (CPU) 15 that selects broadcasting to be received by the tuner 11 and decodes the broadcasting received by the tuner 11. The NAND flash memory 13 stores therein various pieces of information such as an expansion card ID for identifying the expansion card 10, a control program of the expansion card 10, an operating system (OS), graphical user interface (GUI) information that is used for providing a GUI of the expansion card 10 on the mobile terminal device 30. For example, the GUI information includes a layout of graphics as operation images such as windows, icons and buttons to be displayed by the provision of the GUI of the expansion card 10 on the mobile terminal device 30, types of the buttons to be displayed by the provision of the GUI of the expansion card 10 on the mobile terminal device 30, and codes of the buttons. The DDR SDRAM 14 is used as an operation memory of the CPU 15.

Next, a configuration of the information processor 20 according to the embodiment is described. The information processor 20 comprises expansion slots 21-1, 21-2, 21-3, and 21-4, an Ethernet (registered trademark) terminal 22, an Ethernet hub 23, a port processor 24, an application processor 25, a NAND flash memory 27, a DDR SDRAM 28, a panel controller 29, and a display module 291.

The expansion slots (expansion buses) 21-1, 21-2, 21-3, and 21-4 can be connected with external devices such as the expansion card 10. This makes it possible to increase broadcasting that can be received on the information processor 20 in the following manner. That is, for example, the module (expansion card 10) having the function of receiving terrestrial digital broadcasting in a state of being attached to the information processor 20 is mounted for over-the-counter sale and a customer buys the module attached to the information processor 20. After that, the customer purchases the expansion card 10 having the function of receiving specific broadcasting, and connects it to any of the expansion slots 21-1, 21-2, 21-3, and 21-4. Furthermore, when a function to be implemented on the information processor 20 is changed depending on selling areas and grades of the information processor 20, the function to be implemented on the information processor can be changed by changing the expansion card 10 that is connected to any of the expansion slots 21-1, 21-2, 21-3, and 21-4. This eliminates the necessity to manufacture a board dedicated to each selling area and grade of the information processor 20. In the following description, when the expansion slots 21-1, 21-2, 21-3, and 21-4 need not be distinguished from one another, they are simply described as an expansion slot 21. Although the information processor 20 comprises the four expansion slots 21-1, 21-2, 21-3, and 21-4 in the embodiment, the number thereof is not limited thereto. It is sufficient that the information processor 20 comprises at least one expansion slot 21.

Furthermore, in the embodiment, the expansion slot 21 transmits and receives various pieces of information to and from the expansion card 10 connected thereto through a high definition multimedia interface (HDMI) I/F 40 and an Ethernet 41 in accordance with the HDMI standard.

In the embodiment, the expansion slots 21-1, 21-2, 21-3, and 21-4 comprise signal wires 201 through which the expansion cards 10 are capable of acquiring slot information (in the embodiment, slot numbers) indicating the expansion slots 21-1, 21-2, 21-3, and 21-4, as illustrated in FIG. 2. The CPU 15 of the expansion card 10 acquires the slot number in accordance with a signal input through the signal wire 201 comprised by the expansion slot 21. The CPU 15 generates an IP address (hereinafter, referred to as internal communication IP address) of the expansion card 10 itself by using the acquired slot number and communicates with the information processor 20 by using the generated internal communication IP address.

For example, when the expansion card 10 is connected to the expansion slot 21-1, the CPU 15 of the expansion card 10 acquires a value obtained by adding “1” to a signal “00” input through the signal wire 201 as a slot number “1”. Then, as illustrated in FIG. 3, the CPU 15 of the expansion card 10 generates a value “192.0.2.2” as an internal communication IP address eth0 of the expansion card 10 itself. Note that the value “192.0.2.2” is obtained by adding the acquired slot number “1” to a fourth value “1” (value of a least significant byte) of a predetermined internal communication IP address “192.0.2.1” of the application processor 25. As illustrated in FIG. 3, the CPU 15 of the expansion card 10 acquires a slot number so as to generate the internal communication IP address eth0 by using the acquired slot number in the same manner when the expansion card 10 is connected to the expansion slot 21-2, 21-3, or 21-4.

The Ethernet terminal 22 is connected to a wireless local area network (LAN) router 50 so as to communicate with the mobile terminal device 30 with a wireless LAN through the wireless LAN router 50.

The Ethernet hub 23 relays communication among the expansion card 10 connected to the expansion slot 21, the application processor 25, and the mobile terminal device 30.

The port processor 24 selects the expansion slot 21 connected with the expansion card 10 having the function of receiving broadcasting as a display target from the expansion slots 21 (expansion slots 21 connected with the expansion cards 10 each having the function of receiving specific broadcasting). In the embodiment, the port processor 24 is capable of selecting two expansion slots 21 at maximum from the expansion slots 21. Subsequently, the port processor 24 acquires broadcast data of broadcasting received by the expansion card 10 connected to the selected expansion slot 21 from the corresponding expansion card 10. Then, the port processor 24 outputs the acquired broadcast data to the application processor 25 through an HDMI I/F 241.

The NAND flash memory 27 stores therein a main body control program and the like for controlling the information processor 20. The DDR SDRAM 28 is used as an operation memory of a CPU 26 comprised by the application processor 25.

The application processor 25 controls the information processor 20 overall. In the embodiment, the application processor 25 comprises the CPU 26 that executes the main body control program stored in the NAND flash memory 27.

The application processor 25 is connected to the port processor 24 through an I2C bus 242 in addition to the HDMI I/F 241. The CPU 26 controls the port processor 24 through the I2C bus 242. In the embodiment, the CPU 26 detects connection of the new expansion card 10 to the expansion slot 21 through the port processor 24 periodically (for example, once per second).

Then, the CPU 26 generates an internal communication IP address of the detected expansion card 10 by using the predetermined internal communication IP address of itself (application processor 25) and the slot number of the detected expansion card 10. A method of generating the internal communication IP address of the expansion card 10 is the same as the above-mentioned method of generating the internal communication IP address by the CPU 15 of the expansion card 10. Subsequently, the CPU 26 controls the detected expansion card 10 through the Ethernet 41 with a hyper text transfer protocol (HTTP) by using the generated internal communication IP address. Furthermore, the CPU 26 directs the control program of the detected expansion card 10 to transmit various pieces of information of the expansion card 10 (for example, GUI information to be used for providing the GUI of the expansion card 10) through the Ethernet 41 by using the HTTP. In addition, the CPU 26 acquires the various pieces of information of the detected expansion card 10 from the detected expansion card 10.

Furthermore, the CPU 26 controls output of broadcast data to the application processor 25 by the port processor 24 through the I2C bus 242. In other words, the CPU 26 controls selection of the expansion slot 21 by the above-mentioned port processor 24.

The CPU 26 receives the broadcast data output from the port processor 24 through the HDMI I/F 241 and outputs the received broadcast data to the panel controller 29 so as to display a broadcast video image contained in the received broadcast data on a display screen 292 (for example, liquid crystal display (LCD)) comprised by the display module 291.

The CPU 26 communicates with the external wireless LAN router 50 through the Ethernet 41 in order to connect to the network such as the Internet. This enables the CPU 26 to communicate with the mobile terminal device 30 that is capable of inputting operations onto the information processor 20.

In the embodiment, as illustrated in FIG. 3, the CPU 26 has an external communication IP address and sets eth0:0=″192.168.0.2″ to the same network adaptor as that for the internal communication by using an IP alias. The external communication IP address is acquired from the outside by being set by a user previously or being acquired through the wireless LAN router 50 by using a dynamic host configuration protocol (DHCP), for example. Then, the CPU 26 communicates with the wireless LAN router 50 having the IP address eth1=“192.168.0.1” by using the external communication IP address. Although the CPU 26 communicates with the mobile terminal device 30 through the Ethernet 41 in the embodiment, the invention is not limited thereto. For example, the CPU 26 may communicate with the mobile terminal device 30 through Bluetooth (registered trademark) or the like.

Next, a configuration of the mobile terminal device 30 according to the embodiment is described. As illustrated in FIG. 1 and FIG. 4, the mobile terminal device 30 in the embodiment comprises a display module 31, an input module 38, an acceleration sensor 33, an image capturing module 34, a communication module 35, a storage module 36, and a controller 37. In addition, although not illustrated in the drawings, the mobile terminal device 30 also comprises a speaker, a microphone, and the like.

The display module 31 is capable of displaying various pieces of information (for example, graphic by the provision of the GUI of the expansion card 10) under control by the controller 37. To be more specific, the display module 31 comprises a display screen 32 configured by a liquid crystal display (LCD), an organic electro luminescence (EL) display, or the like and is capable of displaying various pieces of information on the display screen 32.

The input module 38 is configured by a pointing device, buttons, and the like, and receives various directions and information input from a user. Although the input module 38 employs a touch panel comprising a transparent coordinate detecting device arranged on the display screen 32 of the display module 31 as the pointing device in the embodiment, the input module is not limited thereto.

The acceleration sensor 33 is a sensing device that senses acceleration of the mobile terminal device 30. For example, the acceleration sensor 33 outputs, as a sensing result, change (inclination and rotation) in the posture of the mobile terminal device 30 in the triaxial direction.

The image capturing module 34 is capable of capturing an image of a subject.

The communication module 35 is a communication interface though which the mobile terminal device 30 is capable of being connected to the network such as the Internet. The communication module 35 is capable of communicating with an external device (for example, information processor 20) connected to the network under control by the controller 37.

The storage module 36 comprises a non-volatile storage medium such as a read only memory (ROM), a hard disk drive (HDD), and a solid state drive (SSD). The storage module 36 stores therein various types of programs such as an application (hereinafter, referred to as a remote control application) that make it possible to operate the information processor 20 with the mobile terminal device 30. The remote control application is downloaded on the network such as the Internet from a server and is stored in the storage module 36.

The controller 37 comprises a CPU, a ROM, a random access memory (RAM), and the like (any of them are not illustrated in the drawings) and corporates with the programs stored in the storage module 36 so as to control the operations of the mobile terminal device 30 overall.

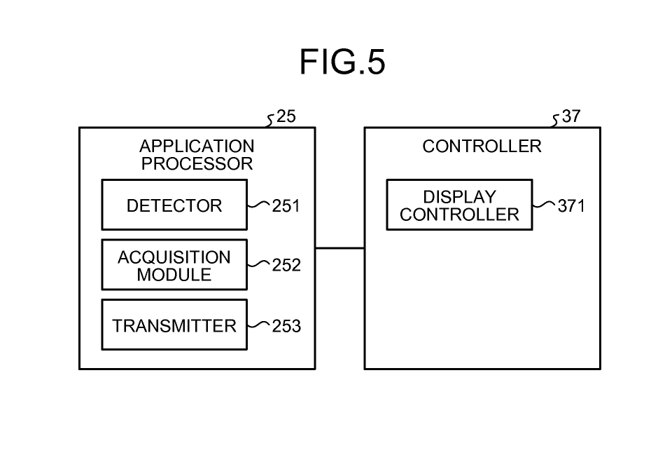

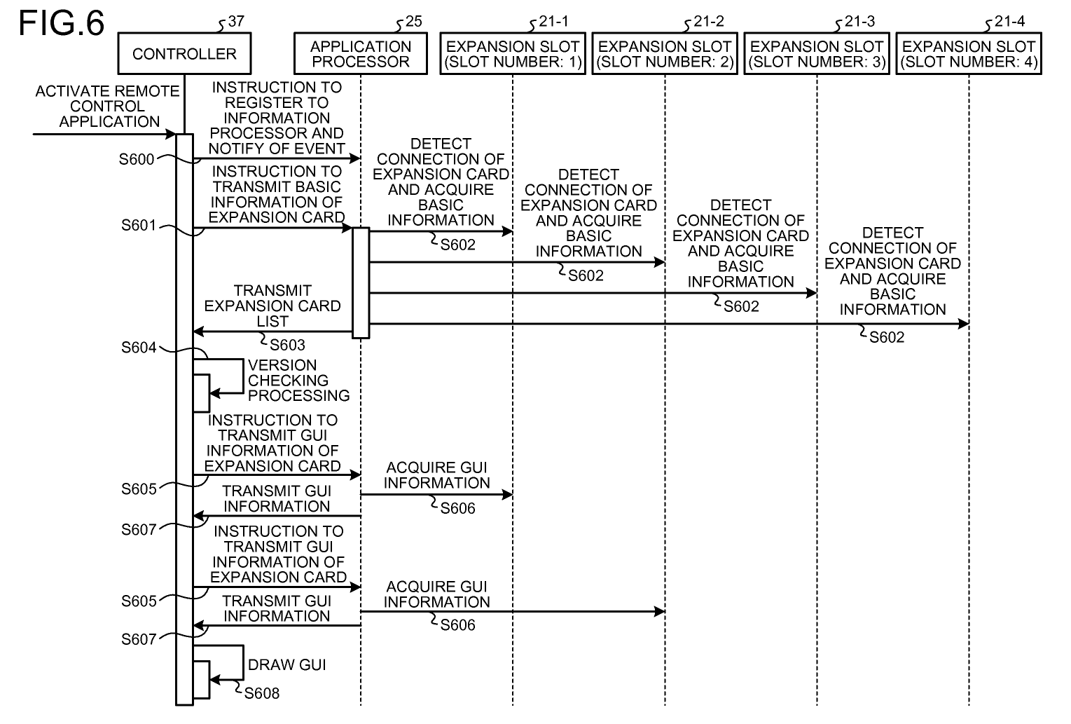

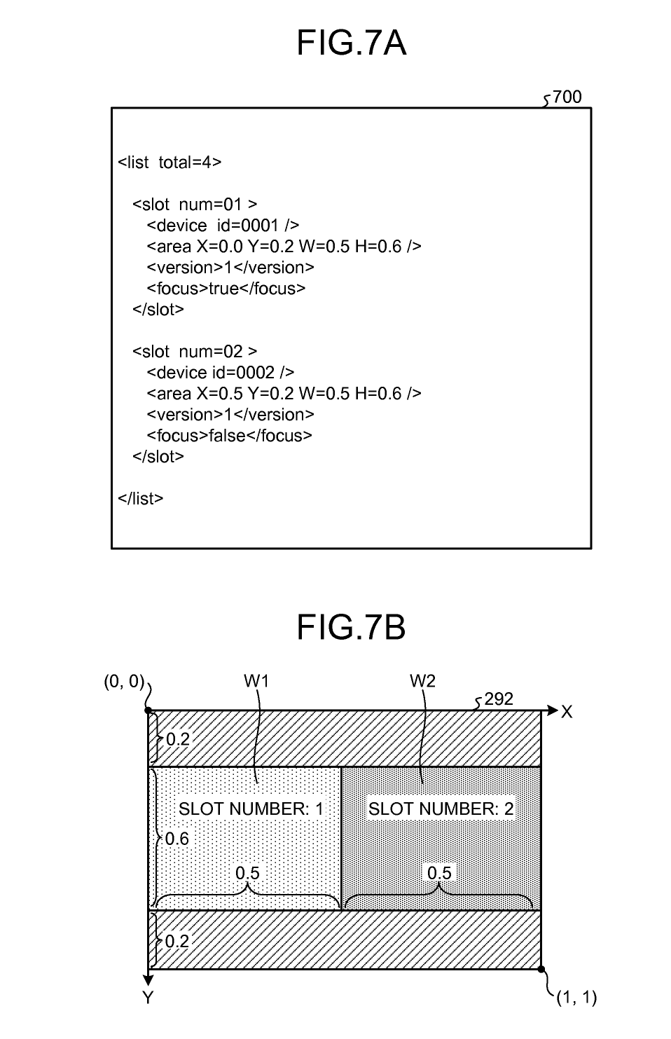

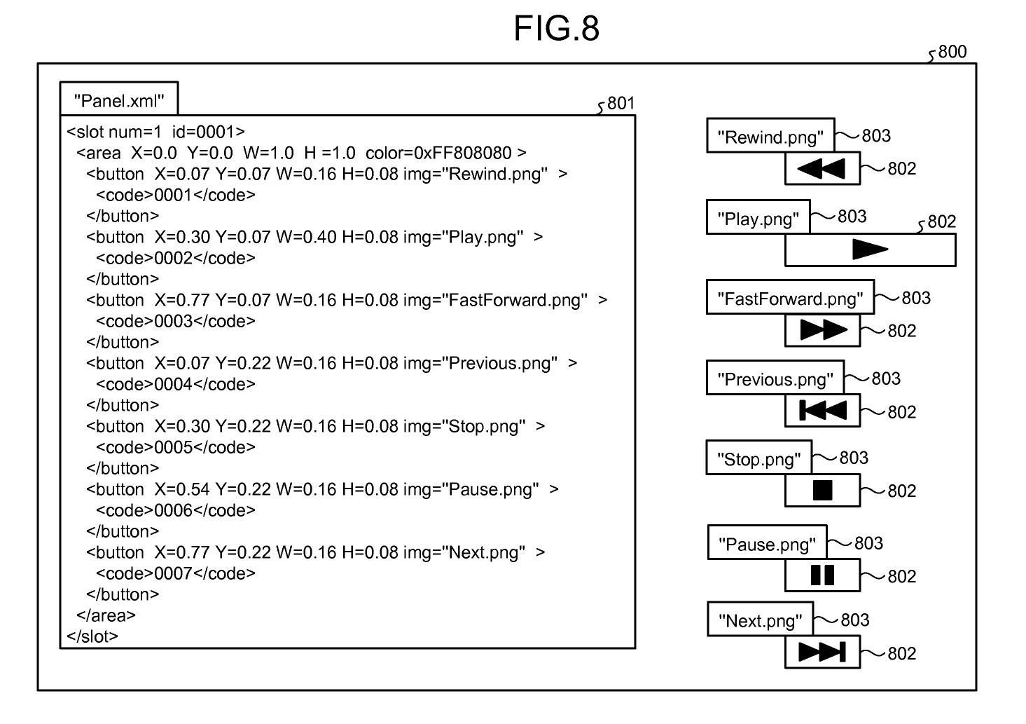

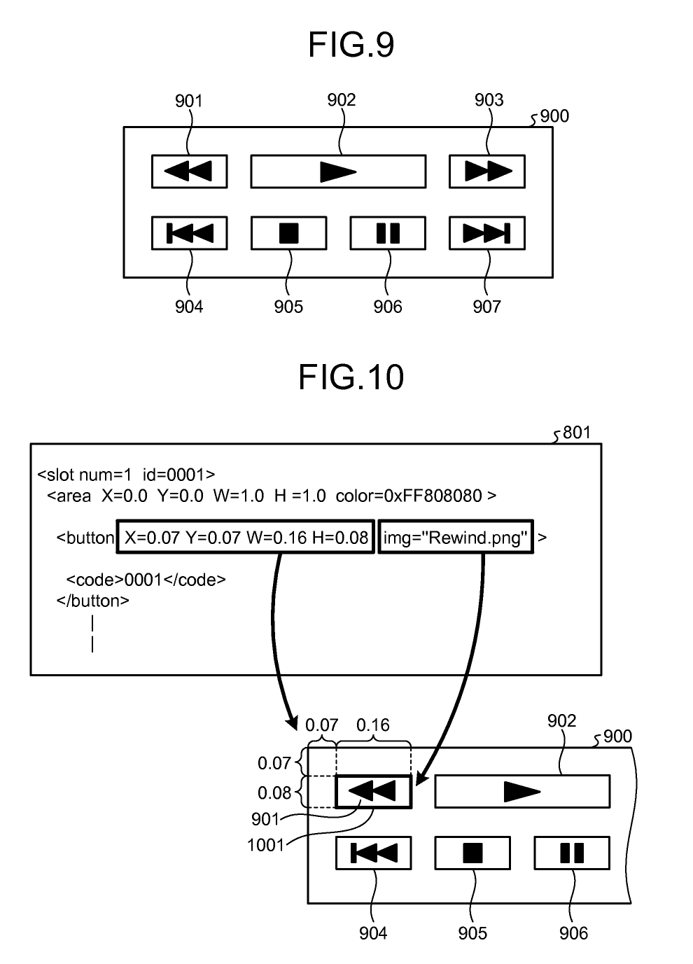

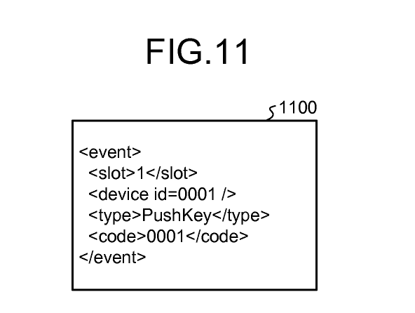

Next, processing of providing a GUI of the expansion card 10 on the mobile terminal device 30 is described with reference to FIGS. 5 to 11. FIG. 5 is a block diagram illustrating functional configurations of the information processor and the mobile terminal device in the embodiment. FIG. 6 is a sequence diagram illustrating flow of the processing of providing the GUI of the expansion card on the mobile terminal device in the display control system in the embodiment. FIGS. 7A and 7B are views illustrating an example of an expansion card list that is transmitted from the information processor in the embodiment. FIG. 8 is a view illustrating an example of GUI information that is transmitted from the information processor in the embodiment. FIG. 9 is a view illustrating an example of an operation console that is displayed on the mobile terminal device in the embodiment. FIG. 10 is a view for explaining processing of displaying the operation console on the mobile terminal device in the embodiment. FIG. 11 is a view illustrating an example of an event that is transmitted by an operation on the operation console displayed on the mobile terminal device in the embodiment.

In the information processor 20, the CPU 26 comprised by the application processor 25 executes the main body control program stored in the NAND flash memory 27 so as to cause a detector 251, an acquisition module 252, and a transmitter 253 to function, as illustrated in FIG. 5. The detector 251 detects a connection with an external device such as the expansion card 10. The acquisition module 252 acquires GUI information from the external device when the detector 251 has detected the connection with the external device. The transmitter 253 transmits the acquired GUI information to the mobile terminal device 30 that is capable of providing the GUI of the external device. Although the mobile terminal device 30 such as a smart phone and a tablet terminal is applied as an example of the operation terminal device that is capable of providing the GUI of the external device (in the embodiment, expansion card 10) in the embodiment, the operation terminal device is not limited thereto as long as it is an operation terminal device that is capable of providing the GUI of the external device. For example, a stationary device such as a notebook PC can be also applied as the operation terminal device that is capable of providing the GUI of the external device.

As illustrated in FIG. 5, in the mobile terminal device 30, the CPU and the like comprised by the controller 37 executes the remote control application stored in the storage module 36 so as to cause a display controller 371 to function. The display controller 371 displays a graphic (hereinafter, referred to as an operation console) by the provision of the GUI of the external device such as the expansion card 10 connected to the information processor 20 on the display module 31 by using the GUI information transmitted from the information processor 20.

If the remote control application is activated, the controller 37 instructs the information processor 20 to register itself (mobile terminal device 30) and to notify various types of events (for example, detection of connection of the expansion card 10) in the information processor 20 (S600). Furthermore, the controller 37 directs the information processor 20 to transmit basic information of the expansion card 10 connected to the expansion slot 21 comprised by the information processor 20 (S601).

If the controller 37 has instructed the information processor 20 to register the mobile terminal device 30 and notify the mobile terminal device 30 of various types of events, the application processor 25 of the information processor 20 stores the IP address of the mobile terminal device 30 in the DDR SDRAM 28 so as to register the mobile terminal device 30. Furthermore, the application processor 25 starts to notify the mobile terminal device 30 of various types of events on the information processor 20 by using the IP address stored in the DDR SDRAM 28.

If the controller 37 has instructed the information processor 20 to transmit the basic information of the expansion card 10 connected to the expansion slot 21, the detector 251 detects connection of the expansion card 10 to each of the expansion slots 21-1, 21-2, 21-3, and 21-4 through the port processor 24 (S602). Furthermore, the acquisition module 252 acquires the basic information from the expansion card 10 that has been detected to be connected by the detector 251 (S602). The basic information indicates information relating to the expansion card 10 such as a slot number of the expansion slot 21 to which the expansion card 10 has been connected, an ID indicating a model number of the expansion card 10, a version of the remote control application required for controlling the expansion card 10, and the like.

In the embodiment, the detector 251 detects the connection of the expansion card 10 to each of the expansion slots 21-1, 21-2, 21-3, and 21-4 through the port processor 24 periodically (or example, once per second). Then, if the detector 251 has detected the connection of the new expansion cards 10 to the expansion slot 21 (for example, expansion slots 21-1 and 21-2), the acquisition module 252 acquires pieces of basic information of the expansion cards 10 connected to the expansion slots 21-1 and 21-2 from the corresponding expansion cards 10.

Although the detector 251 detects the connection of the expansion card 10 to the expansion slot 21 in the embodiment, the embodiment is not limited thereto as long as the detector detects connection of an external device capable of expanding the function of the information processor 20. For example, the detector 251 is also capable of detecting the connection of the external device through the network such as the Internet.

The transmitter 253 transmits an expansion card list containing the acquired basic information of the expansion card 10 to the mobile terminal device 30 (S603). In the embodiment, the transmitter 253 transmits the expansion card list converted in an extensible makeup language (XML) format to the mobile terminal device 30, as illustrated in FIG. 7A. To be more specific, an attribute of a <list> tag contained in an expansion card list 700 indicates the number of the expansion slots 21 (“total=4”) comprised by the information processor 20. Furthermore, the expansion card list 700 contains <slot> tags for the number of the expansion slots 21-1 and 21-2 to which the expansion cards 10 have been detected to be connected.

The attribute of each <slot> tag indicates the slot number (for example, “num=01” and “num=02”) of the expansion slot 21 to which the expansion card 10 has been detected to be connected. The attribute of a <device> tag in each <slot> tag indicates an ID (for example, “id=0001” and “id=0002”) indicating a model number of the expansion card 10 connected to the expansion slot 21.

Furthermore, when the expansion card 10 that has been detected to be connected to the expansion slot 21 has the function of receiving the specific broadcasting and a broadcast view image contained in broadcast data received by the expansion card 10 is displayed on the display screen 292, the attribute of an <area> tag in each <slot> tag indicates the coordinates and the size of a window displaying the broadcast video image on the display screen 292.

For example, when two expansion cards 10 having the function of receiving the specific broadcasting are connected to the expansion slots 21-1 and 21-2, the CPU 26 arranges windows W1 and W2 on the display screen 292. Note that the broadcast video images contained in the pieces of broadcast data received by the two expansion cards 10 are displayed on the windows W1 and W2, respectively. In this case, the attribute of the <area> tag in the <slot num=01> tag indicates the coordinates of the window W1 (in the embodiment, upper left coordinates (X=0.0, Y=0.2) of the window W1) on the display screen 292, and the size of the window W1 (in the embodiment, the width of the window W1 (W=0.5), the height of the window W1 (H=0.6)) on the display screen 292.

Furthermore, the attribute of the <area> tag in the <slot num=02> tag indicates the coordinates of the window W2 (in the embodiment, upper left coordinates (X=0.5, Y=0.2) of the window W2) on the display screen 292, and the size of the window W2 (in the embodiment, the width of the window W2 (W=0.5), the height of the window W2 (H=0.6)) on the display screen 292.

A value of a <version> tag in each <slot> tag indicates a version (for example, “1”) of the remote control application required to control the expansion card 10 connected to the expansion slot 21.

A value of a <focus> tag in each <slot> tag indicates whether the window displaying the broadcast video image of the broadcasting received by the expansion card 10 is an operation target (in other words, is focused) when the expansion card 10 connected to the expansion slot 21 has the function of receiving the specific broadcasting. For example, when the window W1 of the windows W1 and W2 displayed on the display screen 292 as illustrated in FIG. 7B is focused, the value of the <focus> tag in the <slot num=01> is “true” and the value of the <focus> tag in the <slot num=02> is “false”.

Returning to FIG. 6, if the mobile terminal device 30 has received the expansion card list transmitted from the information processor 20, the controller 37 of the mobile terminal device 30 compares the value of the <version> tag contained in the expansion card list with the version of the activated remote control application so as to execute processing (hereinafter, referred to as version checking processing) of detecting the expansion card 10 requiring a remote control application of a version that is newer than the version of the activated remote control application (S604).

When the expansion card 10 requiring the remote control application of the version that is newer than the version of the activated remote control application has been detected, the display controller 371 displays a message indicating that the version of the remote control application is required to be upgraded on the display screen 32 of the display module 31. The remote control application is the application for the mobile terminal device 30 such as a smart phone and a tablet terminal, so that the remote control application is acquired not from the information processor 20 but from the server or the like on the network such as the Internet.

When the expansion card 10 requiring the remote control application of the version that is newer than the version of the activated remote control application has not been detected or when the remote control application of the new version has been acquired, the display controller 371 instructs the information processor 20 to transmit GUI information of the expansion card 10 connected to the expansion slot 21 of the slot number indicated by the attribute of the <slot> tag contained in the expansion card list (S605). In the embodiment, the display controller 371 directs the information processor 20 to transmit the GUI information of the expansion card 10 connected to the expansion slot 21 for each of the expansion slots 21 of the slot numbers indicated by the attributes of the <slot> tags contained in the expansion card list.

If the information processor 20 has received the direction to transmit the GUI information from the mobile terminal device 30, the acquisition module 252 of the information processor 20 transmits the received direction to transmit the GUI information to the expansion card 10 through the Ethernet 41 and the Ethernet hub 23. Then, the acquisition module 252 acquires the GUI information from the expansion card 10 (S606). In the embodiment, the acquisition module 252 acquires the GUI information containing the slot number of the expansion slot 21 to which the expansion card 10 is connected for each of the expansion cards 10 connected to the expansion slots 21-1 and 21-2. To be more specific, the GUI information contains layout information indicating a layout of an operation console to be displayed by the provision of the GUI of the expansion card 10, image data of buttons contained in the operation console of the expansion card 10, codes for identifying the buttons contained in the operation console of the expansion card 10, and the like.

To be more specific, as illustrated in FIG. 8, GUI information 800 contains layout information 801 in an XML format and pieces of image data 802. The layout information 801 indicates the layout of the buttons and the like contained in the operation console of the expansion card 10 and codes to be transmitted when the buttons are pressed (operated). The pieces of image data 802 are pieces of data of the buttons contained in the operation console of the expansion card 10. Furthermore, image codes 803 as an example of unique information that make it possible to identify the pieces of image data 802 are added to the respective pieces of image data 802.

As illustrated in FIG. 8, the layout information 801 in the XML format contains a <slot> tag of which attribute is the slot number (for example, “num=1”) of the expansion slot 21 connected with the expansion card 10 of which GUI information has been acquired and the ID (for example, “id=0001”) indicating the model number of the expansion card 10 connected to the expansion slot 21 of the corresponding slot number.

The <slot> tag contains an <area> tag as a tag of the operation console of the expansion card 10, <button> tags as tags of widget such as the buttons contained in the operation console of the expansion card 10, and the like. The attribute of the <area> tag indicates the coordinates of the operation console of the expansion card 10 (in the embodiment, upper left coordinates (X=0.0,Y=0.0) of the operation console of the expansion card 10) on the display screen 32 of the mobile terminal device 30, the size of the operation console of the expansion card 10 (in the embodiment, the width (W=1.0) of the operation console of the expansion card 10 and the height (H=1.0) of the operation console of the expansion card 10) on the display screen 32, and the color (color=0xFF808080) of the operation console of the expansion card 10.

Furthermore, the attribute of each <button> tag indicates the coordinates of each button on the operation console of the expansion card 10 (in the embodiment, upper left coordinates (for example, X=0.07,Y=0.07) of the button on the operation console of the expansion card 10), the size of the button on the operation console of the expansion card 10 (for example, the width (W=0.16) of the button, the height (H=0.08) of the button), and the image code (for example, img=“Rewind.png”) of the image data of the button contained in the operation console of the expansion card 10, and the like.

The <button> tag contains a <code> tag indicating a value of a code (for example, “0001”) that is transmitted to the information processor 20 when the button contained in the operation console of the expansion card 10 has been pressed.

Returning to FIG. 6, if the acquisition module 252 has acquired the GUI information, the transmitter 253 transmits the acquired GUI information to the mobile terminal device 30 (S607). This provides the GUI of the expansion card 10 on the mobile terminal device 30 in real time in accordance with the attachment of the expansion card 10 to the information processor 20.

The display controller 371 of the mobile terminal device 30 draws the operation console of the expansion card 10 connected to the information processor 20 in the storage module 36 by using the GUI information received from the information processor 20 to display the operation console drawn in the storage module 36 on the display screen 32 of the display module 31 (S608). This causes the display controller 371 to provide the GUI of the expansion card 10 connected to the expansion slot 21 of the information processor 20.

In the embodiment, as illustrated in FIG. 9, the display controller 371 draws a background image 900 of the widget (for example, buttons) contained in the operation console of the expansion card 10 in the storage module 36. In this case, the display controller 371 draws the background image 900 in accordance with the size of the operation console of the expansion card 10 and the color of the operation console of the expansion card 10 that are indicated by the attribute of the <area> tag in the <slot> tag of the layout information 801 contained in the GUI information.

Then, the display controller 371 draws the operation console on which images 901 to 907 of the buttons based on the pieces of image data 802 having the image codes indicated by the attributes of the <button> tags are arranged on the background image 900 in the storage module 36. In this case, the images 901 to 907 of the buttons are arranged in accordance with the coordinates of the buttons and the sizes of the buttons that are indicated by the attributes of the <button> tags in the <slot> tag of the layout information 801 contained in the GUI information.

For example, as illustrated in FIG. 10, when the display controller 371 draws the image 901 of the button contained in the operation console of the expansion card 10 having the ID (“id=0001”) indicated by the attribute of the <slot> tag of the layout information 801 contained in the GUI information, the display controller 371 sets the coordinates (X=0.07, Y=0.07) indicated by the attribute of the <button> tag of the button to the upper left coordinates and specifies a rectangular region 1001 having the width (W=0.16) of the button and the height (H=0.08) of the button that are indicated by the attribute of the <button> tag of the button on the background image 900 drawn in the storage module 36. Then, the display controller 371 draws the image 901 based on the image data 802 having the image code (“img=“Rewind.png””) indicated by the attribute of the <button> tag of the button on the specified rectangular region 1001.

In the embodiment, the display controller 371 draws the operation console in the storage module 36 for each expansion card 10 having the ID indicated by the attribute of the <slot> tag of the layout information 801 contained in the GUI information.

If the display controller 371 has displayed the operation console on the display screen 32 of the display module 31, and then, the button contained in the operation console has been operated, the display controller 371 transmits the value (for example, “0001”) of the <code> tag contained the <button> tag of the operated button in the layout information 801 contained in the GUI information to the expansion card 10 through the Ethernet hub 23 of the information processor 20 so as to control the expansion card 10.

In the embodiment, if the button contained in the operation console displayed on the display screen 32 is operated, the display controller 371 transmits an event in the XML format containing the value of the <code> tag contained in the <button> tag of the operated button to the expansion card 10 through the Ethernet hub 23 of the information processor 20.

For example, if the button of the <button> tag having the value “0001” of the <code> tag in the layout information 801 has been pressed, the display controller 371 transmits an event 1100 in the XML format to the expansion card 10. As illustrated in FIG. 11, the event 1100 contains a <slot> tag having a value of the slot number “num=1” as the attribute of the <slot> tag containing the <button> tag of the pressed button in the layout information 801, a <device id> tag of which attribute is the ID “id=0001” as the attribute of the <slot> tag containing the <button> tag of the pressed button, a <type> tag having a value of “Push Key” indicating that the button has been pressed, and a <code> tag. With this, the display controller 371 transmits control information containing the slot number indicating the expansion slot 21 connected with the expansion card 10 that relates to control of the external device by using the GUI and is controlled by using the GUI to the information processor 20.

The Ethernet hub 23 (communication module) of the information processor 20 receives the control information from the mobile terminal device 30 and transmits the received control information to the expansion card 10 connected to the expansion slot 21 in accordance with the slot number contained in the received control information. To be more specific, if the Ethernet hub 23 has received the control information, the Ethernet hub 23 specifies the internal communication IP address of the expansion card 10 by using the slot number contained in the received control information. For example, the Ethernet hub 23 specifies a value “192.0.2.2” as the internal communication IP address of the expansion card 10 as the control target. Note that the value “192.0.2.2” is obtained by adding the slot number “1” contained in the received control information to a fourth value “1” of the IP address eth0=″192.0.2.1″ of the information processor 20 itself. Furthermore, the Ethernet hub 23 transmits the received control information to the expansion card 10 having the specified IP address. This enables the mobile terminal device 30 to control the expansion card 10 through the information processor 20.

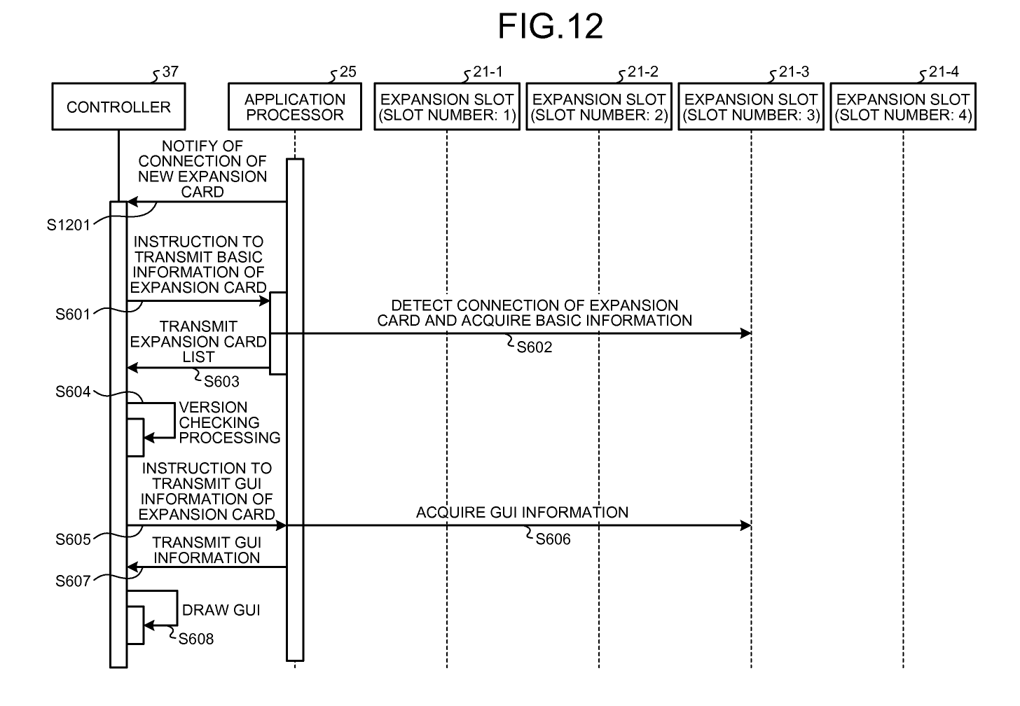

Next, described is processing of causing the mobile terminal device 30 to provide the GUI of a new expansion card 10 when the new expansion card 10 has been connected to the information processor 20 with reference to FIG. 5 and FIG. 12. FIG. 12 is a sequence diagram illustrating flow of the processing of causing the mobile terminal device to provide the GUI of the new expansion card in the display control system in the embodiment.

The detector 251 of the information processor 20 detects connection of the expansion card 10 to the expansion slot 21 through the port processor 24 periodically while the IP address of the mobile terminal device 30 is stored in the DDR SDRAM 28 and the mobile terminal device 30 is registered. Then, if the detector 251 has detected the connection of the new expansion card 10 to the expansion slot 21-3, the application processor 25 notifies the mobile terminal device 30 of the connection of the new expansion card 10 (S1201).

If the mobile terminal device 30 has been notified of the connection of the new expansion card 10, the application processor 25 and the controller 37 executes processing of providing the GUI of the new expansion card 10 in the same manner as S601 to S608 in FIG. 6.

On the other hand, although not illustrated in the drawings, if the connection of the expansion card 10 to the expansion slot 21 has no longer been detected, the transmitter 253 transmits termination information for terminating the GUI (GUI of the expansion card 10 that has no longer been detected to be connected) provided on the mobile terminal device 30 to the mobile terminal device 30 through the Ethernet hub 23. This makes it possible to terminate the GUI that is provided on the mobile terminal device 30 in real time in accordance with detachment of the expansion card 10 from the information processor 20. In the embodiment, when the connection of the expansion card 10 to the expansion slot 21 has no longer been detected, the transmitter 253 transmits information indicating that the expansion card 10 has been disconnected to the mobile terminal device 30 as the termination information.

If the display controller 371 of the mobile terminal device 30 has received the termination information from the information processor 20, the display controller 371 terminates the display of the operation console of the disconnected expansion card 10 on the display screen 32.

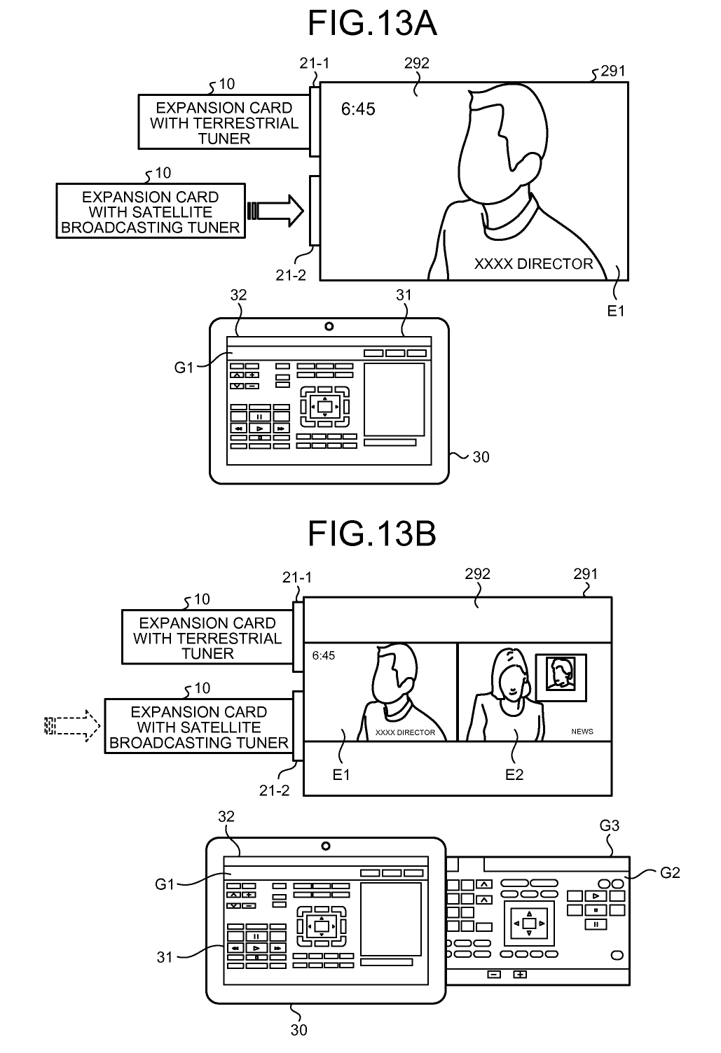

Next, described is processing of displaying GUIs of the expansion cards 10 on the mobile terminal device 30 with reference to FIGS. 13A and 13B. FIGS. 13A and 13B are views for explaining the processing of displaying the GUIs of the expansion cards 10 on the mobile terminal device comprised by the display control system in the embodiment.

For example, when the expansion card 10 (expansion card 10 having a terrestrial tuner capable of receiving terrestrial television broadcasting) has been connected to the expansion slot 21-1 only, the CPU 26 comprised by the application processor 25 receives broadcast data of broadcasting received by the expansion card 10 connected to the expansion slot 21-1 through the port processor 24. Then, the CPU 26 outputs the received broadcast data to the panel controller 29 so as to display a broadcast video image E1 contained in the received broadcast data on the display screen 292 comprised by the display module 291, as illustrated in FIG. 13A.

Furthermore, as illustrated in FIG. 13A, the display controller 371 of the mobile terminal device 30 displays an operation console G1 of a GUI of the expansion card 10 connected to the expansion slot 21-1 on the display screen 32 comprised by the display module 31 by using GUI information transmitted from the transmitter 253 so as to provide the GUI of the expansion card 10 connected to the expansion slot 21-1.

Thereafter, when the new expansion card 10 (expansion card 10 having a satellite broadcasting tuner capable of receiving BS television broadcasting) has been connected to the expansion slot 21-2, the CPU 26 receives the broadcast data of the broadcasting received by the expansion card 10 connected to the expansion slot 21-1 and broadcast data of broadcasting received by the expansion card 10 connected to the expansion slot 21-2 through the port processor 24. Then, the CPU 26 outputs the two pieces of received broadcast data of the broadcasting to the panel controller 29 so as to display broadcast video images E1 and E1 contained in the two pieces of received broadcast data of the broadcasting on the display screen 292 comprised by the display module 291, as illustrated in FIG. 13B.

Furthermore, as illustrated in FIG. 13B, the display controller 371 of the mobile terminal device 30 displays the operation console G1 of the expansion card 10 connected to the expansion slot 21-1 and an operation console G2 of the expansion card 10 connected to the expansion slot 21-2 on the display screen 32 comprised by the display module 31 by using the respective pieces of GUI information of the two expansion cards 10 that are transmitted from the transmitter 253 so as to provide the GUIs of the respective expansion cards 10 connected to the expansion slots 21-1 and 21-2.

In the embodiment, when the display controller 371 has received the pieces of GUI information of the two expansion cards 10 from the transmitter 253, the display controller 371 draws an image G3 that contains the operation console G1 and the operation console G2 of the two received expansion cards 10 and is larger than the display screen 32 in the storage module 36. Then, the display controller 371 displays a part (for example, any one of the two operation consoles G1 and G2) of the image G3 drawn in the storage module 36 on the display screen 32. For example, the display controller 371 displays the operation console of the expansion card 10 that receives the broadcasting of the broadcast video image displayed on the window as an operation target on the display screen 292 of the information processor 20 in two operation consoles G1 and G2 contained in the image G3 on the display screen 32.

In this manner, the information processor 20 in the embodiment that is capable of expanding the function with the connection of the expansion cards 10 comprises the detector 251, the acquisition module 252, and the transmitter 253. The detector 251 detects connection of the expansion card 10. The acquisition module 252 acquires GUI information to be used for providing a GUI of the expansion card 10 from the expansion card 10 when the detector 251 has detected the connection of the expansion card 10. The transmitter 253 transmits the GUI information to the mobile terminal device 30 comprising the display module 31 capable of displaying an operation image by the provision of the GUI. With this, the information processor 20 is capable of controlling the provision of the GUI of the expansion card 10 on the mobile terminal device 30 in real time in accordance with attachment and detachment of the expansion card 10 to and from the information processor 20.

Computer programs to be executed in the information processor 20 and the mobile terminal device 30 in the embodiment may be configured to be provided by being recorded in a computer-readable recording medium, such as a compact disc read only memory (CD-ROM), a flexible disk (FD), a CD recordable (CD-R), or a digital versatile disk (DVD), in a format that can be installed or a file that can be executed.

The programs to be executed in the information processor 20 and the mobile terminal device 30 in the embodiment may be configured to be provided by being stored on a computer connected to the network such as the Internet and being downloaded through the network. Alternatively, the programs to be executed in the information processor 20 and the mobile terminal device 30 in the embodiment may be provided or distributed through the network such as the Internet.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processor capable of expanding a function by connecting an external device therewith, the information processor comprising:
a detector configured to detect a connection with the external device;
an acquisition module configured to acquire, when the detector has detected the connection with the external device, graphical user interface (GUI) information to be used for providing a GUI of the external device from the external device; and
a transmitter configured to transmit the GUI information to an operation terminal device capable of providing the GUI.

2. The information processor of claim 1, wherein, when the detector no longer detects the connect in with the external device, the transmitter is configured to transmit termination information for terminating the GUI provided on the operation terminal device to the operation terminal device.

3. The information processor of claim 2, wherein, when the detector no longer detects the connection with the external device, the transmitter is configured to transmit, as the termination information, information indicating that the external device has been disconnected to the operation terminal device.

4. The information processor of claim 1, further comprising an expansion slot to which the external device is capable of being connected, wherein
the detector is configured to detect a connection of the external device with the expansion slot.

5. The information processor of claim 4, further comprising a communication module configured to receive, from the operation terminal device, control information of the external device that contains slot information indicating the expansion slot connected with the external device to be controlled by using the GUI, and to transmit the received control information to the external device in accordance with the slot information contained in the received control information.

6. The information processor of claim 5, wherein the communication module is configured to specify an Internet Protocol (IP) address of the external device by using the slot information contained in the received control information, and to transmit the received control information to the external device of the specified IP address.

7. The information processor of claim 4, wherein the acquisition module is configured to acquire the GUI information containing slot information indicating the expansion slot connected with the external device from the external device.

8. The information processor of claim 1, wherein the detector is configured to detect a connection with the external device through a network.

9. A display control method performed by an information processor capable of expanding a function by connecting an external device therewith, the display control method comprising:
detecting, by a detector, a connection with the external device;
acquiring, by an acquisition module and when the detector has detected the connection with the external device, graphical user interface (GUI) information to be used for providing a GUI of the external device from the external device; and
transmitting, by a transmitter, the GUI information to an operation terminal device capable of providing the GUI.
